(19) United States
(12) Patent Application Publication
(10) Pub. No.: US 2005/0125973 A1
(43) Pub. Date: Jun. 16, 2005

(54) Vault for containing cremation urn

(76) Inventors: Bryan M. Hankel, Batesville, IN (US); Tom Heil, Batesville, IN (US); Christopher M. Wessel, Batesville, IN (US)

Correspondence Address: WOOD, HERRON & EVANS, LLP, 2700 CAREW TOWER, 441 VINE STREET, CINCINNATI, OH, 45202, US

(21) Appl. No.: 10/732,095

(22) Filed: Dec. 10, 2003

(51) Int. Cl. A61G 17/00

(52) U.S. Cl. 27/1

(57) ABSTRACT

A cremation urn vault comprises a vault base including an opening communicating with a cavity configured to receive therein a cremation urn, a cover securable over the opening of the base, a memorabilia compartment incorporated in the vault for receiving and storing keepsakes and mementos and a record tube incorporated in the vault for receiving and storing a record of the deceased whose remains are contained in the cremation urn.

This invention relates generally to the funeral industry, and more particularly to the cremation segment of the funeral industry.

### BACKGROUND OF THE INVENTION

Cremation is a growing segment of the funeral industry. Consequently, there is an increasing demand for more and higher quality styles and designs of cremation remains containers. To that end the assignee of the present invention has responded with new and innovative cremation remains containers which are sculptural works of art. The family of the deceased may choose to display such a sculptural artwork cremation remains container in their home upon a fireplace mantle or the like. Alternatively, a family may prefer to bury the cremation remains container in much the same way a traditional burial casket is interred in the earth. In the case of the latter, it is desirable to first place the cremation remains container or urn in a cremation urn vault prior to burial. The cremation urn vault safeguards and shelters the cremation urn within, sustaining the earth's weight and resisting the elements.

It is the purpose of the present invention to provide an improved cremation urn vault with a number of functional features incorporated therein.

### SUMMARY OF THE INVENTION

The present invention is a cremation urn vault comprising a vault base including an opening communicating with a cavity configured to receive therein a cremation urn, a cover securable over the opening of the base, a memorabilia compartment incorporated in the vault for receiving and storing keepsakes and mementos and a record tube incorporated in the vault for receiving and storing a record of the deceased whose remains are contained in the cremation urn.

The memorabilia compartment can be in the cover. Preferably, the cover must be removed from the base to access the interior of the memorabilia compartment.

The record tube can be in the base. Preferably, the interior of the record tube can be accessed without removing the cover.

The vault can further comprise a pair of handles secured to the base facilitating handling of the vault.

The vault can further comprise a gasket interposed between the cover and the base.

The memorabilia compartment can be a recess formed in an underneath side of the cover, and a plate overlying the recess to retain the keepsakes and mementos therein during installation of the cover on the base.

The cover can include an engravable plate on an upper surface thereof.

The base and cover can be fabricated of granite, marble or a concrete polymer composite.

The vault can include a locking system for locking the cover on the base. The locking system can be hex head screws securing the cover on the base, and a hex head key for actuating the hex head screws.

In another aspect, a method of memorializing a deceased comprises providing an urn vault having a memorabilia compartment and a record tube, placing cremated remains in the urn vault, placing keepsakes and mementos in the memorabilia compartment and placing a record of the deceased in the record tube.

Preferably the urn vault includes a cover, and preferably the memorabilia compartment is only accessible with the cover removed, whilst the record tube is accessible without the cover removed.

These and other features and advantages of the present invention will become more readily apparent during the following detailed description taken in conjunction with the drawings herein, in which:

### BRIEF DESCRIPTION OF THE DRAWINGS OF THE INVENTION

FIG. 1 is a perspective view of the cremation urn vault of the present invention;

FIG. 2 is view taken along line 2-2 of FIG. 1; and

FIG. 3 is a view taken along line 3-3 of FIG. 1.

### DETAILED DESCRIPTION OF THE INVENTION

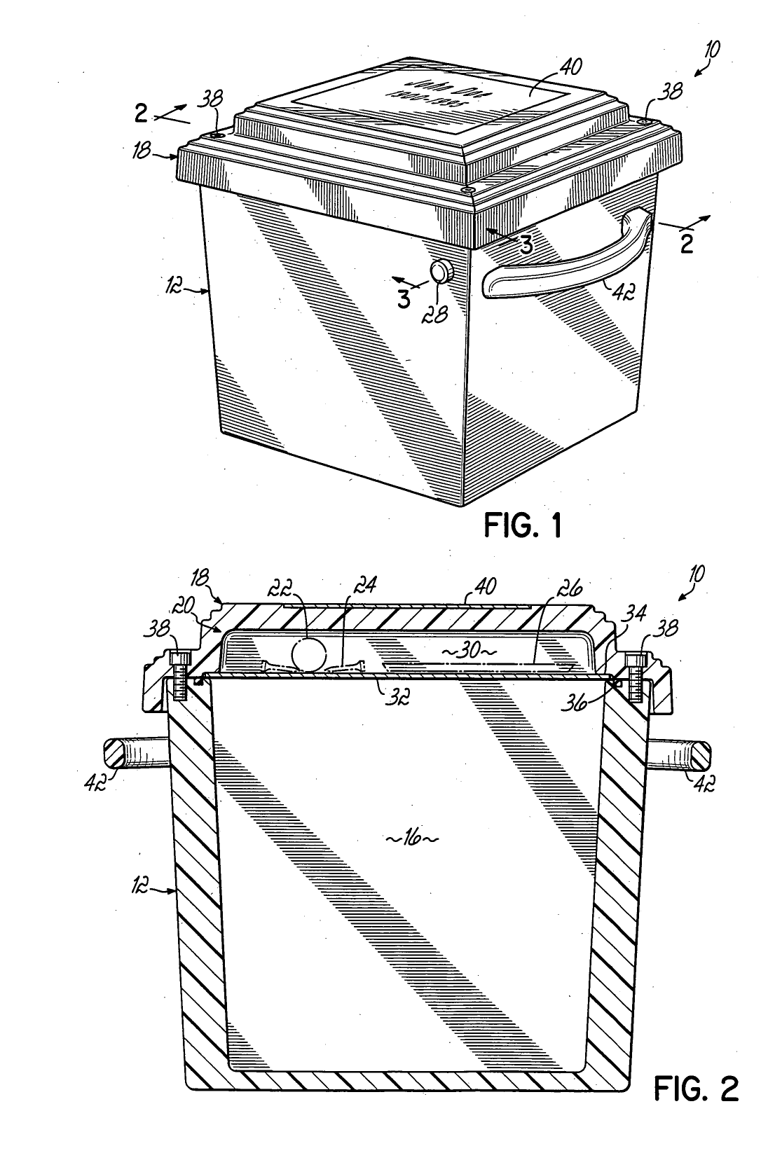

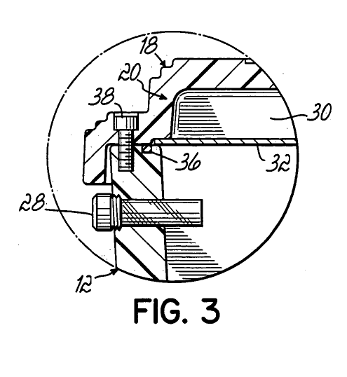

Referring to FIGS. 1-3, there is illustrated a cremation urn vault 10 according to the principles of the present invention. The vault 10 includes a vault base 12 including an opening 14 communicating with a cavity 16. The cavity 16 is configured to receive therein a cremation urn (not shown). Alternatively, the vault 10 can be utilized to receive and store cremation remains directly without first placing the remains in an urn. A cover 18 is securable over the opening 14 of the base 12. A memorabilia compartment 20 is incorporated in the vault and is for receiving and storing keepsakes and mementos such as golf ball 22, golf tees 24 and picture 26. A record tube 28 is also incorporated in the vault 10 for receiving and storing a record of the deceased whose remains are contained in the cremation urn.

As illustrated, the memorabilia compartment 20 can be a recess 30 formed in an underneath side of the cover 18. A plate 32 can overlie the recess 30, resting upon shoulder 34, to retain the keepsakes and mementos 22, 24, 26 therein during installation of the cover 18 on the base 12.

A gasket 36 can provide sealing between the cover 18 and base 12. The cover 18 can be secured to the base 12 via hex head screws 38 which can be applied with a decorative hex head locking key, not unlike those used to lock burial caskets and which are presented to the surviving loved ones of the deceased as a memento. The cover 18 can also include an engravable plate 40 on an upper surface thereof.

A pair of handles 42, 42 can be secured to the base 12 to facilitate handling of the vault 10.

The base 12 and cover 18 can be fabricated of granite, marble or a concrete polymer composite, or any other suitable material.

Those skilled in the art will readily recognize numerous adaptations and modifications which can be made to the present invention which will result in an improved cremation urn vault, yet all of which will fall within the spirit and scope of the present invention as defined in the following claims. Accordingly, the invention is to be limited only by the scope of the following claims and their equivalents.

1. A cremation urn vault comprising:
a vault base including an opening communication with a cavity configured to receive therein a cremation urn;
a cover securable over said opening of said base;
a memorabilia compartment incorporated in said vault for receiving and storing keepsakes and mementos; and
a record tube incorporated in said vault for receiving and storing a record of the deceased whose remains are contained in the cremation urn.

2. The vault of claim 1 wherein said memorabilia compartment is in said cover.

3. The vault of claim 2 wherein said cover must be removed from said base to access an interior of said memorabilia compartment.

4. The vault of claim 1 wherein said record tube is in said base.

5. The vault of claim 4 wherein an interior of said record tube can be accessed without removing said cover.

6. The vault of claim 1 further comprising a pair of handles secured to said base facilitating handling of said vault.

7. The vault of claim 1 further comprising a gasket interposed between said cover and said base.

8. The vault of claim 2 wherein said memorabilia compartment is a recess formed in an underneath side of said cover.

9. The vault of claim 8 wherein said cover includes a plate overlying said recess to retain the keepsakes and mementos therein during installation of said cover on said base.

10. The vault of claim 1 wherein said cover includes an engraveable plate on an upper surface thereof.

11. The vault of claim 1 wherein said base and cover are fabricated of granite.

12. The vault of claim 1 wherein said base and cover are fabricated of marble.

13. The vault of claim 1 wherein said base and cover are fabricated of a concrete polymer composite.

14. The vault of claim 1 further including a locking system for locking said cover on said base.

15. The vault of claim 14 wherein said locking system comprises hex head screws securing said cover on said base, and a hex head key for actuating said hex head screws.

16. A method of memorializing a deceased comprising:
providing an urn vault having a memorabilia compartment and a record tube;
placing cremated remains in the urn vault;
placing keepsakes and mementos in the memorabilia compartment; and
placing a record of the deceased in the record tube.

17. The method of claim 16 wherein the urn vault includes a cover, and wherein the memorabilia compartment is only accessible with the cover removed, whilst the record tube is accessible without the cover removed.
